(19) United States
(12) Patent Application Publication
(10) Pub. No.: US 2026/0072508 A1
(43) Pub. Date: Mar. 12, 2026

(54) METHOD AND APPARATUS FOR PROVIDING HAPTIC FEEDBACK COMBINING TACTILE AND FORCE FEEDBACK

(71) Applicant: ELECTRONICS AND TELECOMMUNICATIONS RESEARCH INSTITUTE, Daejeon (KR)

(72) Inventors: Daegeun PARK, Daegeun (KR); Ju-Young Kim, Daejeon (KR); Sung-Uk Jung, Daejeon (KR); Yeong-Jae Choi, Daejeon (KR)

(21) Appl. No.: 19/317,486

(22) Filed: Sep. 3, 2025

(30) Foreign Application Priority Data
Jul. 30, 2025 (KR) 10-2025-0103828
Sep. 6, 2024 (KR) 10-2024-0121478

(51) Int. Cl. G06F 3/01

(52) U.S. Cl. CPC G06F 3/016; G06F 3/014

(57) ABSTRACT

Disclosed herein are a method and apparatus for providing haptic feedback combining tactile and force feedback. The apparatus for providing haptic feedback includes a glove body including a serial segmented skeleton and a fingertip thimble provided for each finger, and formed of a glove-shaped inner lining, a tactile feedback module configured to provide a tactile feedback by the collision based on multiple vibration motors attached to the fingertip thimble and the inner lining, a force feedback module configured to provide a force feedback by the collision based on two flexible shafts passing through guide tunnels included in the serial segmented skeleton while being located on both sides of the finger, and a linear actuator pushing or pulling the two flexible shafts, and a processor configured to control the tactile feedback module and the force feedback module in response to the collision.

### BACKGROUND OF THE INVENTION

1. Technical Field

The present disclosure relates generally to a technology for providing haptic feedback combining tactile and force feedback, and more particularly to a technology for providing realistic haptic feedback by combining diverse tactile feedback and multi-directional force feedback when a user interacts with both real and virtual objects in an eXtended Reality (XR) environment.

### 2. Description of the Related Art

Most commercially available haptic gloves for virtual reality interactions are limited to providing tactile feedback using a vibration motor in a Virtual Reality (VR) environment, restricting their ability to support a wide range of virtual reality interactions. Some haptic gloves use a tendon-driven method to provide force feedback with a simplified structure. However, since these haptic gloves only passively stop finger movement or use friction, they are limited in conveying diverse dynamic forces involved in virtual interactions to a user.

To overcome these limitations, some haptic gloves have been developed that implement force feedback using a mechanical mechanism. However, due to weight and volume constraints, they provide force feedback only through simple motions, such as finger bending and stretching, which makes it difficult to implement realistic interactions in a virtual environment. Moreover, most of these haptic gloves have multiple elements on the inner side of the hand, which causes a significant sense of incongruity due to the glove structure when interacting with real objects in the XR environment.

### [Prior Art Documents]

### [Patent Documents]

(Patent Document 1) U.S. Patent Application Publication No. US2020/0282302, Date of Publication: September 10, 2020 (Title: Exo tendon motion capture glove device with haptic grip response)

### SUMMARY OF THE INVENTION

This application claims the benefit of Korean Patent Application Nos. 10-2024-0121478, filed September 6, 2024 and 10-2025-0103828, filed July 30, 2025, which are hereby incorporated by reference in their entireties into this application.

Accordingly, the present disclosure has been made keeping in mind the above problems occurring in the prior art, and an object of the present disclosure is to provide multi-tactile and multi-directional force feedback by simultaneously operating a tactile feedback module and a force feedback module when a user interacts with various objects in a virtual environment.

Another object of the present disclosure is to provide an apparatus and method employing an exoskeleton structure to minimize the sense of incongruity when contacting real objects in an XR environment.

In accordance with an aspect of the present disclosure to accomplish the above objects, there is provided an apparatus for providing haptic feedback combining tactile and force feedback based on collision with a virtual object in a virtual environment, the apparatus including a glove body including a serial segmented skeleton and a fingertip thimble provided for each finger, and formed of a glove-shaped inner lining; a tactile feedback module configured to provide a tactile feedback by the collision based on multiple vibration motors attached to the fingertip thimble and the inner lining; a force feedback module configured to provide a force feedback by the collision based on two flexible shafts passing through guide tunnels included in the serial segmented skeleton while being located on both sides of the finger, and a linear actuator pushing or pulling the two flexible shafts; and a processor configured to control the tactile feedback module and the force feedback module in response to the collision.

The serial segmented skeleton may be composed of multiple arcuate segmented skeletons considering a length of the finger, and a lateral movement joint, and each of the multiple arcuate segmented skeletons may be provided with two guide tunnels.

The fingertip thimble, the multiple arcuate segmented skeletons, and the lateral movement joint may be connected.

The serial segmented skeleton may bend toward a palm or extend toward a back of the hand as gaps between the connected arcuate segmented skeletons open or close, and may bend to the left or right while the lateral movement joint connected to a mount fixing part attached to the inner lining via a pin joint rotates left or right.

The force feedback module may control the serial segmented skeleton to bend toward or extend from the palm by pushing or pulling the two flexible shafts in an identical direction, and may control the serial segmented skeleton to bend to the left or right by pushing or pulling the two flexible shafts in opposite directions.

The force feedback module may push the two flexible shafts in a distal direction of the finger through the linear actuator, when the virtual object collides in a direction where the finger is bent, and may pull the two flexible shafts in a proximal direction of the finger through the linear actuator, when the virtual object collides in a direction where the finger is extended.

The multiple vibration motors may be attached to the fingertips, palm, and back of the hand, respectively.

The tactile feedback module may operate at least one vibration motor located at a point of collision with the virtual object, among the multiple vibration motors.

The apparatus for providing haptic feedback may further include a communication module configured to receive data in response to collision with the virtual object.

Further, there is provided a method for providing haptic feedback combining tactile and force feedback based on collision with a virtual object in a virtual environment, the method being performed by an apparatus for providing haptic feedback, the method including controlling a tactile feedback module based on a processor to operate multiple vibration motors attached to a glove body, thereby providing a tactile feedback due to the collision; and controlling a force feedback module based on the processor to push or pull two flexible shafts located on both sides of each finger, thereby providing the force feedback due to the collision, and wherein the two flexible shafts pass through guide tunnels included in a serial segmented skeleton that constitutes the glove body.

The serial segmented skeleton may be composed of multiple arcuate segmented skeletons considering a length of the finger, and a lateral movement joint, and each of the multiple arcuate segmented skeletons may be provided with two guide tunnels.

The fingertip thimble, the multiple arcuate segmented skeletons, and the lateral movement joint may be connected.

The serial segmented skeleton may bend toward a palm or extend toward a back of the hand as gaps between the connected arcuate segmented skeletons open or close, and may bend to the left or right while the lateral movement joint connected to a mount fixing part attached to the inner lining via a pin joint rotates left or right.

The force feedback module may control the serial segmented skeleton to bend toward or extend from the palm by pushing or pulling the two flexible shafts in an identical direction, and may control the serial segmented skeleton to bend to the left or right by pushing or pulling the two flexible shafts in opposite directions.

The force feedback module may push the two flexible shafts in a distal direction of the finger through a linear actuator, when the virtual object collides in a direction where the finger is bent, and may pull the two flexible shafts in a proximal direction of the finger through the linear actuator, when the virtual object collides in a direction where the finger is extended.

The multiple vibration motors may be attached to the fingertips, palm, and back of the hand, respectively.

The tactile feedback module may operate at least one vibration motor located at a point of collision with the virtual object, among the multiple vibration motors.

The method for providing haptic feedback may further include, by the apparatus for providing haptic feedback, receiving data in response to collision with the virtual object via a communication module.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating an apparatus for providing haptic feedback combining tactile and force feedback according to an embodiment of the present disclosure.

FIG. 2 is a detailed view illustrating a fingertip thimble of the apparatus for providing haptic feedback illustrated in FIG. 1;

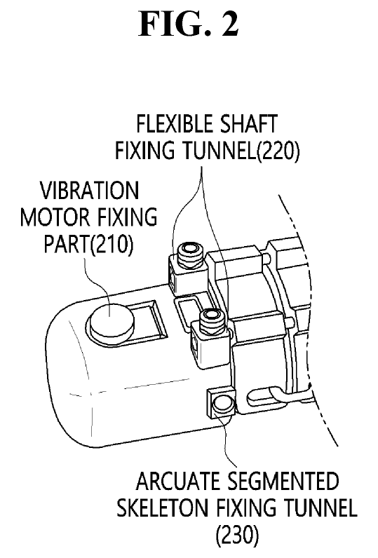

FIG. 3 is a detailed view illustrating an exoskeleton structure of the apparatus for providing haptic feedback illustrated in FIG. 1;

FIG. 4 is a detailed view illustrating a force feedback module of the apparatus for providing haptic feedback illustrated in FIG. 1;

FIGS. 5 and 6 are diagrams illustrating an example in which the force feedback module according to an embodiment of the present disclosure is driven;

FIGS. 7 and 8 are diagrams illustrating a tactile feedback module and an example in which the tactile feedback module is driven according to an embodiment of the present disclosure;

FIG. 9 is an operation flowchart illustrating a method for providing haptic feedback combining tactile and force feedback according to an embodiment of the present disclosure; and

FIG. 10 is a diagram illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, embodiments of the present disclosure will be described in detail with reference to the attached drawings.

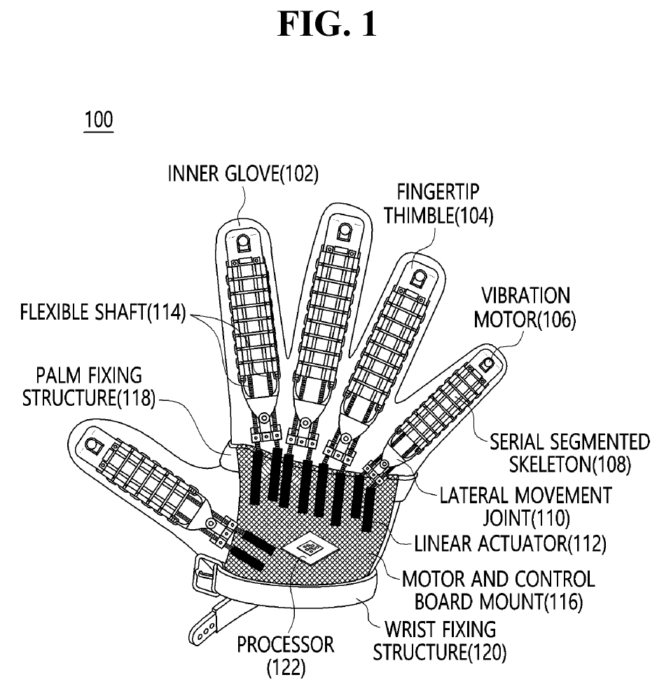

FIG. 1 is a diagram illustrating an apparatus for providing haptic feedback combining tactile and force feedback according to an embodiment of the present disclosure.

Referring to FIG. 1, the apparatus for providing haptic feedback combining tactile and force feedback according to an embodiment of the present disclosure may be broadly divided into a glove body corresponding to an exoskeleton structure, a tactile feedback module, a force feedback module, and a processor.

To be more specific, the glove body corresponding to the exoskeleton structure may include an inner glove 102, a fingertip thimble 104, a serial segmented skeleton 108 including a lateral movement joint 110, a motor and control board mount 116, a palm fixing structure 118, and a wrist fixing structure 120. The tactile feedback module may include a vibration motor 106, and the force feedback module may include a linear actuator 112 and two flexible shafts 114.

Hereinafter, the apparatus for providing haptic feedback based on this structure will be described in more detail.

First, in the apparatus for providing haptic feedback combining tactile and force feedback based on collision with a virtual object in a virtual environment, the glove body includes the serial segmented skeleton 108 and the fingertip thimble 104 provided for each finger, and is implemented as the glove-shaped inner glove 102.

That is, the present disclosure proposes the exoskeleton-type glove body that conveys interaction between the hand and the virtual object in the XR environment to a user using the tactile feedback module and the force feedback module, and minimizes the sense of incongruity that may occur when contacting a real object while wearing the apparatus.

Here, the structure of the glove body may correspond to a structure to which the tactile feedback module and the force feedback module, which will be described later, may be attached.

For example, the inner glove 102 may be in the form of a ready-made glove made of cloth or soft polymer, allowing the user to easily wear the apparatus according to the present disclosure. Therefore, the size of the inner glove 102 may be adjusted to fit the user’s hand, and the inner glove may be made of a material that allows easy attachment and detachment, such as Velcro, on the back of the hand or fingertips to facilitate the mounting and removal of various components.

Referring to FIG. 1, the motor and control board mount 116 made of flexible plastic may be attached to the hand back area of the inner glove 102 using Velcro or the like.

In order to fix the motor and control board mount 116, the wrist fixing structure 120 and the palm fixing structure 118, made of a cloth belt or flexible plastic, may be attached to a wrist area and a middle of the palm of the inner glove 102. This allows the motor and control board mount 116 to be firmly attached to the inner glove 102.

Here, a fastening device such as a belt loop or Velcro may be applied to the end of each of the wrist fixing structure 120 and the palm fixing structure 118 to facilitate easy opening and fastening.

The fingertip thimble 104 is designed to firmly secure the structure of the entire glove body, the vibration motor 106 of the tactile feedback module, and the flexible shaft 114 of the force feedback module to the user’s hand. Here, the fingertip thimble 104 may be made in various sizes to accommodate different finger thicknesses of the user.

Further, the fingertip thimble 104 may be mounted in a form where the end of the inner glove 102 is inserted into the thimble, and they may be fastened using a component that allows easy attachment and detachment, such as Velcro.

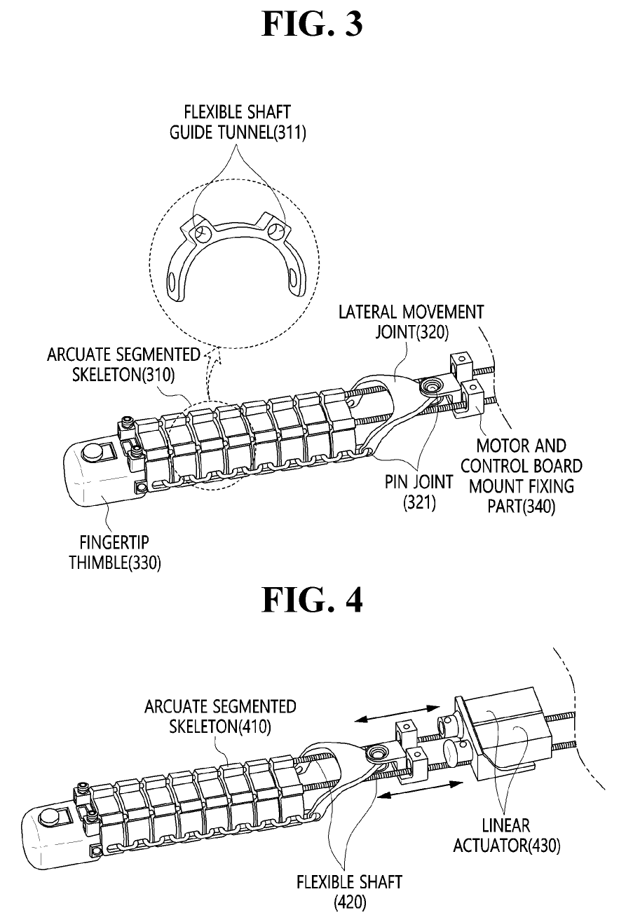

FIG. 3 specifically illustrates a fingertip thimble portion, and the upper side of the fingertip thimble (corresponding to an area above the fingernail) may include a vibration motor fixing part 210 to which the vibration motor 106 may be attached. Further, a flexible shaft fixing tunnel 220 may be provided to secure two flexible shafts 114 to the upper side of the fingertip thimble using a screw or the like, and arcuate segmented skeleton fixing tunnels 230 may be provided on both sides of the fingertip thimble for attaching the arcuate segmented skeleton.

Here, the serial segmented skeleton 108 may be composed of multiple arcuate segmented skeletons considering the length of the finger, and lateral movement joints 110. Each of the arcuate segmented skeletons may be provided with two guide tunnels.

Here, the fingertip thimble 104, multiple arcuate segmented skeletons and lateral movement joint 110 may be connected.

For example, referring to FIG. 3, multiple arcuate segmented skeletons 310 may be connected in series according to the length of the user’s finger, and the fingertip thimble 330 and the lateral movement joint 320 may be attached to both ends of the serial segmented skeleton connected in this way.

Here, the arcuate segmented skeletons 310, the arcuate segmented skeleton 310 and the fingertip thimble 330, and the arcuate segmented skeleton 310 and the lateral movement joint 320 may be connected using small rings or thin wires, respectively.

The serially connected serial segmented skeleton may ensure that the finger may freely bend and straighten.

Here, the guide tunnels 311 through which two flexible shafts pass may be positioned above the arcuate segmented skeleton 310.

Here, the lateral movement joint 320 is connected in the form of a pin joint 321 between a proximal end of the arcuate segmented skeleton 310 and the motor and control board mount 116 attached to the inner glove 102, allowing for the free adduction/abduction movement of the finger.

Further, in the apparatus for providing haptic feedback combining tactile and force feedback based on collision with the virtual object in the virtual environment, the tactile feedback module provides a tactile feedback by collision based on multiple vibration motors 106 attached to the fingertip thimbles 104 and the inner glove 102.

Here, the multiple vibration motors 106 may be attached to the fingertips, palm, and back of the hand, respectively.

The tactile feedback module may operate at least one vibration motor located at the point of collision with the virtual object, among the multiple vibration motors 106.

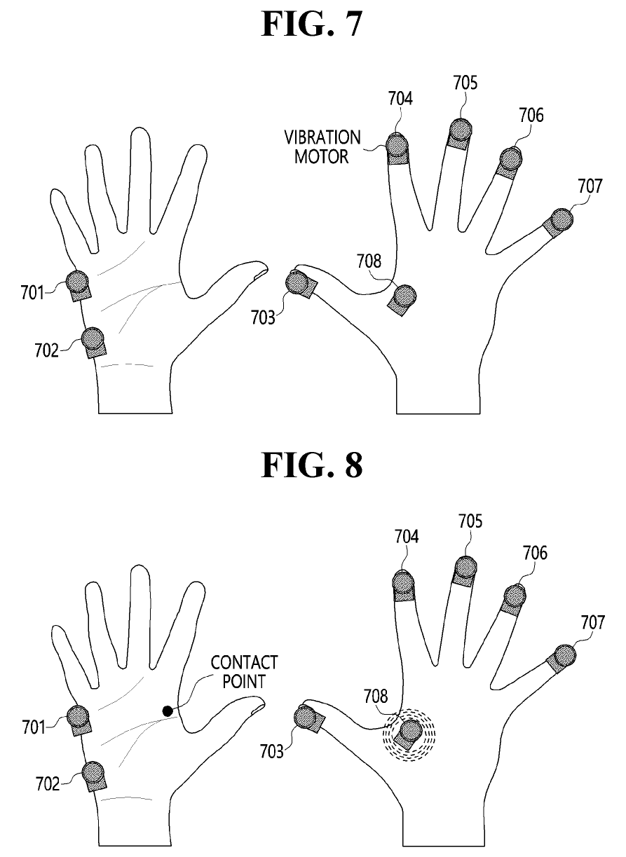

For example, referring to FIG. 7, the tactile feedback module may include at least eight vibration motors 701 to 708 per side of the glove body (one on each fingernail and three or more on the palm).

As illustrated in FIG. 8, when a user touches the virtual object in the XR environment, feedback may be provided so that he or she can feel various tactile feedback in a wide range by vibrating the vibration motor 708 around a contact point where the contact occurs.

For example, each of the vibration motors 701 to 708 may be attached to the fingertip thimble and a palm fixing structure that partially covers the palm, using an easily attachable and detachable element such as Velcro. Further, the attachment positions of the vibration motors 701 to 708 may vary depending on the user’s hand size or sensory sensitivity.

Further, in the apparatus for providing haptic feedback combining tactile and force feedback based on collision with the virtual object in the virtual environment, the force feedback module provides the force feedback by collision based on the two flexible shafts 114 passing through the guide tunnels included in the serial segmented skeleton 108 while being located on both sides of the finger, and the linear actuator 112 pushing or pulling the two flexible shafts 114.

Here, the serial segmented skeleton 108 may bend toward the palm or extend toward the back of the hand as gaps between the connected arcuate segmented skeletons open or close. Also, the serial segmented skeleton 108 may bend to the left or right while the lateral movement joint 110, which is connected to a mount fixing part attached to the inner glove 102 via the pin joint, rotates left or right.

Here, the force feedback module may control the serial segmented skeleton 108 to bend toward or extend from the palm by pushing or pulling the two flexible shafts 114 in the same direction. It may also control the serial segmented skeleton 108 to bend to the left or right by pushing or pulling the two flexible shafts 114 in opposite directions.

When the virtual object collides in a direction where the finger is bent, the force feedback module pushes the two flexible shafts 114 in the distal direction of the finger through the linear actuator 112. Meanwhile, when the virtual object collides in a direction where the finger is extended, the force feedback module may pull the two flexible shafts 114 in the proximal direction of the finger through the linear actuator 112.

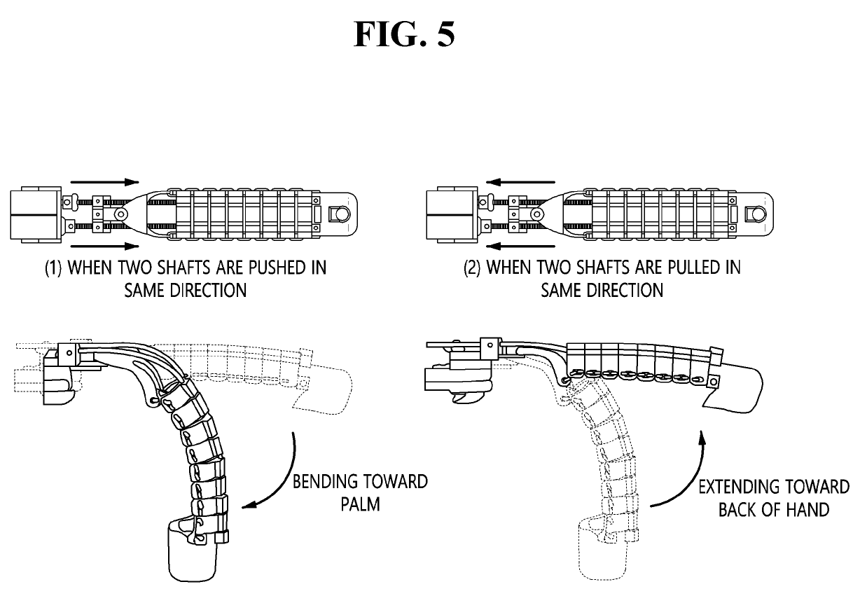

For example, referring to FIG. 4, the force feedback module may be composed of two flexible shafts 420 and two linear actuators 430 for each finger. The two flexible shafts 420 may pass through the guide tunnels 311 illustrated in FIG. 3 and be fastened to the fingertip thimble 330 and the two linear actuators 430 using a screw or the like.

Here, the two linear actuators 430 may be fastened onto the motor and control board mount 116 illustrated in FIG. 1 using a screw or the like, and may provide multidirectional active force feedback to the finger by pushing or pulling the two flexible shafts 420.

For example, the linear actuator 430 according to the present disclosure may be positioned on the motor and control board mount and controlled by the processor 122 or control board driven by a battery or external power source.

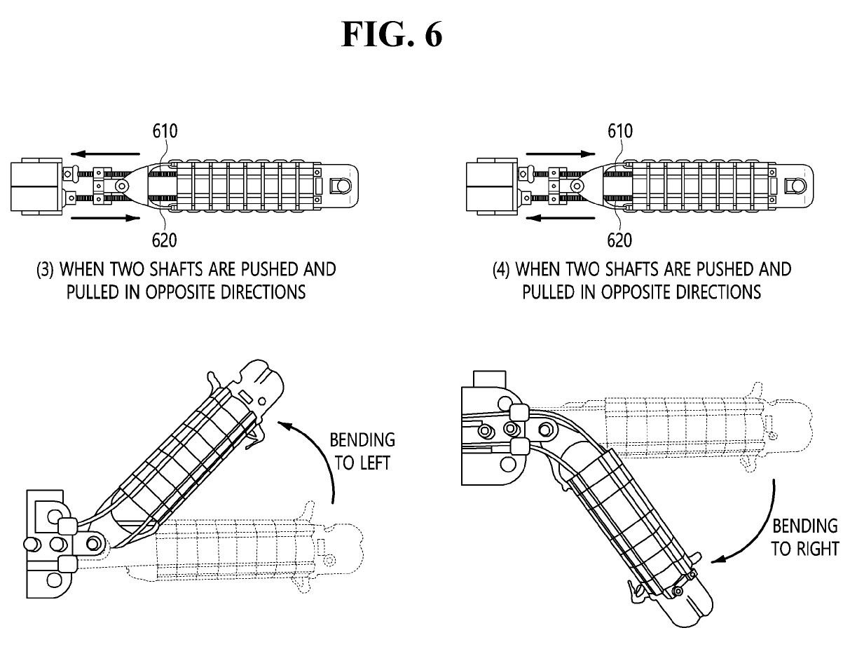

Hereinafter, an operation example of the force feedback module according to the present disclosure will be described in detail with reference to FIGS. 5 and 6.

First, the force feedback module according to the present disclosure can actively deliver the multidirectional force feedback to the user by driving two shafts considering the direction of momentum generated by the collision when the user collides with the virtual object in the XR environment.

For example, when the virtual object collides in the direction where the finger is bent, as illustrated in FIG. 5(1), the two shafts may be pushed equally toward the distal direction of the finger, thereby delivering the force feedback of the finger bending toward the palm.

As another example, when the virtual object collides in the direction where the finger is extended, as illustrated in FIG. 5(2), the two shafts may be pulled equally toward the proximal direction of the finger, thereby delivering the force feedback of the finger extending toward the back of the hand.

As a further example, when the virtual object collides from the left or right direction of the finger, as illustrated in FIG. 6, the two shafts 610 and 620 may be pushed and pulled to move in opposite directions, thereby delivering the force feedback of the finger bending to the left or right. To be more specific, when the virtual object collides from the right side of the finger, the shaft 610 located on the left side of the finger may be pulled, and the shaft 620 located on the right side of the finger may be pushed. In contrast, when the virtual object collides from the left side of the finger, the shaft 610 located on the left side of the finger may be pushed, and the shaft 620 located on the right side of the finger may be pulled.

Further, in the apparatus for providing haptic feedback combining tactile and force feedback based on collision with the virtual object in the virtual environment, the processor 122 controls the tactile feedback module and the force feedback module in response to the collision.

For example, the processor may be a central processing unit or a semiconductor device that executes processing instructions stored in memory or storage.

The apparatus for providing haptic feedback combining tactile and force feedback based on collision with the virtual object in the virtual environment may further include a communication module that receives data in response to collision with the virtual object, although not illustrated in FIG. 1.

By using such an apparatus for providing haptic feedback, a user can experience much more realistic and diverse physical interactions by experiencing, through various sensations, various interactions that occur when contacting and colliding with various objects beyond a boundary between reality and virtuality in the XR environment.

Furthermore, by positioning multiple feedback modules on the back of the hand using the exoskeleton structure, the user can maintain a natural sensation in the palm where actual contact occurs even when touching real as well as virtual objects in the XR environment. This enables realistic interaction in both real and virtual environments.

Although the above description focuses on a structure that may be worn on the hand, the apparatus for providing haptic feedback according to the present disclosure may be modified to be worn on a joint structure that moves in various directions, for example, a joint that has a structure that bends and extends, such as an arm, leg, or waist, thereby providing feedback to a wider range of body parts.

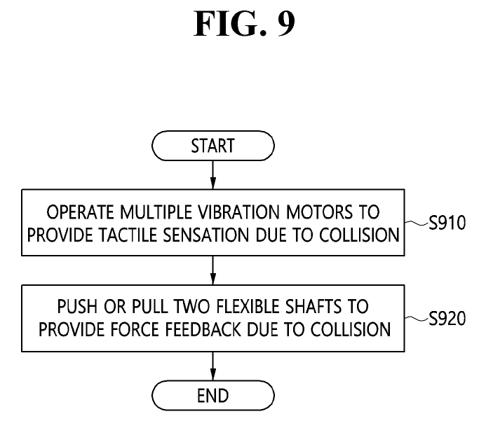

FIG. 9 is an operation flowchart illustrating a method for providing haptic feedback combining tactile and force feedback according to an embodiment of the present disclosure.

Referring to FIG. 9, according to the method for providing haptic feedback combining tactile and force feedback according to an embodiment of the present disclosure, in the method for providing haptic feedback combining tactile and force feedback based on collision with a virtual object in a virtual environment, the apparatus for providing haptic feedback controls a tactile feedback module based on a processor to operate multiple vibration motors attached to a glove body, thereby providing a tactile feedback due to the collision, at step S910.

Here, the multiple vibration motors may be attached to the fingertips, palm, and back of the hand, respectively.

The tactile feedback module may operate at least one vibration motor located at the point of collision with the virtual object, among the multiple vibration motors.

Further, according to the method for providing haptic feedback combining tactile and force feedback according to an embodiment of the present disclosure, in the method for providing haptic feedback combining tactile and force feedback based on collision with the virtual object in the virtual environment, the apparatus for providing haptic feedback controls a force feedback module based on the processor to push or pull two flexible shafts located on both sides of each finger, thereby providing the force feedback due to the collision, at step S920.

Here, the two flexible shafts may pass through guide tunnels included in a serial segmented skeleton that constitutes the glove body.

Here, the serial segmented skeleton may be composed of multiple arcuate segmented skeletons considering the length of the finger, and lateral movement joints. Each of the arcuate segmented skeletons may be provided with two guide tunnels.

Here, the fingertip thimble, the multiple arcuate segmented skeletons and the lateral movement joint may be connected.

Here, the serial segmented skeleton may bend toward the palm or extend toward the back of the hand as gaps between the connected arcuate segmented skeletons open or close. The serial segmented skeleton may bend to the left or right while the lateral movement joint structure, which is connected to a mount fixing part attached to an inner lining via a pin joint, rotates left or right.

Here, the force feedback module may control the serial segmented skeleton to bend toward or extend from the palm by pushing or pulling the two flexible shafts in the same direction. It may also control the serial segmented skeleton to bend to the left or right by pushing or pulling the two flexible shafts in opposite directions.

When the virtual object collides in a direction where the finger is bent, the force feedback module pushes the two flexible shafts in the distal direction of the finger through the linear actuator. Meanwhile, when the virtual object collides in a direction where the finger is extended, the force feedback module may pull the two flexible shafts in the proximal direction of the finger through the linear actuator.

Further, according to the method for providing haptic feedback combining tactile and force feedback according to an embodiment of the present disclosure, in the method for providing haptic feedback combining tactile and force feedback based on collision with the virtual object in the virtual environment, the apparatus for providing haptic feedback receives data corresponding to collision with the virtual object through a communication module.

Through such a method for providing haptic feedback, a user can experience much more realistic and diverse physical interactions by experiencing, through various sensations, various interactions that occur when contacting and colliding with various objects beyond a boundary between reality and virtuality in an XR environment.

Furthermore, by positioning multiple feedback modules on the back of the hand using an exoskeleton structure, a user can maintain a natural sensation in the palm where actual contact occurs even when touching real as well as virtual objects in an XR environment. This enables realistic interaction in both real and virtual environments.

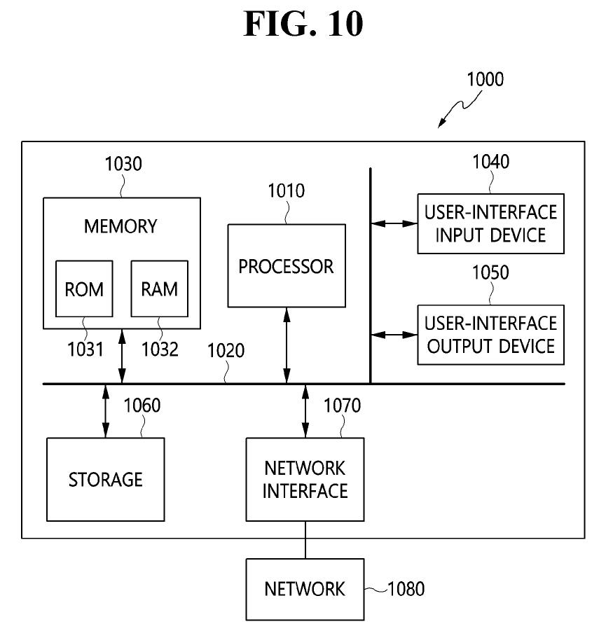

FIG. 10 is a diagram illustrating a computer system according to an embodiment of the present disclosure.

Referring to FIG. 10, an apparatus for providing a haptic feedback according to an embodiment of the present disclosure may be implemented in a computer system such as a computer-readable storage medium. As illustrated in FIG. 10, a computer system 1000 may include one or more processors 1010, memory 1030, a user interface input device 1040, a user interface output device 1050, and a storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be any of various types of volatile or nonvolatile storage media. For example, the memory 1030 may include Read-Only Memory (ROM) 1031 or Random Access Memory (RAM) 1032.

Therefore, the embodiment of the present disclosure may be implemented as a non-transitory computer-readable medium in which a computer-implemented method or computer-executable instructions are stored. When the computer-readable instructions are executed by the processor, the computer-readable instructions may perform the method according to at least one aspect of the present disclosure.

According to the present disclosure, a user can experience much more realistic and diverse physical interactions by experiencing, through various sensations, various interactions that occur when contacting and colliding with various objects beyond a boundary between reality and virtuality in an XR environment.

Furthermore, the present disclosure utilizes an exoskeleton structure to position multiple feedback modules on the back of the hand, thereby allowing a user to maintain a natural sensation in the palm where actual contact occurs even when touching real as well as virtual objects in an XR environment. This enables realistic interaction in both real and virtual environments.

As described above, in the method and apparatus for providing haptic feedback combining tactile and force feedback according to the present disclosure, the configurations and schemes in the above-described embodiments are not limitedly applied, and some or all of the above embodiments can be selectively combined and configured such that various modifications are possible.

WHAT IS CLAIMED IS:

1. An apparatus for providing haptic feedback combining tactile and force feedback based on collision with a virtual object in a virtual environment, the apparatus comprising:
a glove body including a serial segmented skeleton and a fingertip thimble provided for each finger, and formed of a glove-shaped inner lining;
a tactile feedback module configured to provide a tactile feedback by the collision based on multiple vibration motors attached to the fingertip thimble and the inner lining;
a force feedback module configured to provide a force feedback by the collision based on two flexible shafts passing through guide tunnels included in the serial segmented skeleton while being located on both sides of the finger, and a linear actuator pushing or pulling the two flexible shafts; and
a processor configured to control the tactile feedback module and the force feedback module in response to the collision.

2. The apparatus of claim 1, wherein the serial segmented skeleton is composed of multiple arcuate segmented skeletons considering a length of the finger, and a lateral movement joint, and each of the multiple arcuate segmented skeletons is provided with two guide tunnels.

3. The apparatus of claim 2, wherein the fingertip thimble, the multiple arcuate segmented skeletons, and the lateral movement joint are connected.

4. The apparatus of claim 3, wherein the serial segmented skeleton bends toward a palm or extends toward a back of the hand as gaps between the connected arcuate segmented skeletons open or close, and bends to the left or right while the lateral movement joint connected to a mount fixing part attached to the inner lining via a pin joint rotates left or right.

5. The apparatus of claim 4, wherein the force feedback module controls the serial segmented skeleton to bend toward or extend from the palm by pushing or pulling the two flexible shafts in an identical direction, and controls the serial segmented skeleton to bend to the left or right by pushing or pulling the two flexible shafts in opposite directions.

6. The apparatus of claim 5, wherein the force feedback module pushes the two flexible shafts in a distal direction of the finger through the linear actuator, when the virtual object collides in a direction where the finger is bent, and pulls the two flexible shafts in a proximal direction of the finger through the linear actuator, when the virtual object collides in a direction where the finger is extended.

7. The apparatus of claim 1, wherein the multiple vibration motors are attached to the fingertips, palm, and back of the hand, respectively.

8. The apparatus of claim 7, wherein the tactile feedback module operates at least one vibration motor located at a point of collision with the virtual object, among the multiple vibration motors.

9. The apparatus of claim 1, further comprising:
a communication module configured to receive data in response to collision with the virtual object.

10. A method for providing haptic feedback combining tactile and force feedback based on collision with a virtual object in a virtual environment, the method being performed by an apparatus for providing haptic feedback, the method comprising:
controlling a tactile feedback module based on a processor to operate multiple vibration motors attached to a glove body, thereby providing a tactile feedback due to the collision; and
controlling a force feedback module based on the processor to push or pull two flexible shafts located on both sides of each finger, thereby providing the force feedback due to the collision, and
wherein the two flexible shafts pass through guide tunnels included in a serial segmented skeleton that constitutes the glove body.

11. The method of claim 10, wherein the serial segmented skeleton is composed of multiple arcuate segmented skeletons considering a length of the finger, and a lateral movement joint, and each of the multiple arcuate segmented skeletons is provided with two guide tunnels.

12. The method ofclaim 11, wherein the fingertip thimble, the multiple arcuate segmented skeletons, and the lateral movement joint are connected.

13. The method of claim 12, wherein the serial segmented skeleton bends toward a palm or extends toward a back of the hand as gaps between the connected arcuate segmented skeletons open or close, and bends to the left or right while the lateral movement joint connected to a mount fixing part attached to the inner lining via a pin joint rotates left or right.

14. The method of claim 13, wherein the force feedback module controls the serial segmented skeleton to bend toward or extend from the palm by pushing or pulling the two flexible shafts in an identical direction, and controls the serial segmented skeleton to bend to the left or right by pushing or pulling the two flexible shafts in opposite directions.

15. The method of claim 14, wherein the force feedback module pushes the two flexible shafts in a distal direction of the finger through a linear actuator, when the virtual object collides in a direction where the finger is bent, and pulls the two flexible shafts in a proximal direction of the finger through the linear actuator, when the virtual object collides in a direction where the finger is extended.

16. The method of claim 10, wherein the multiple vibration motors are attached to the fingertips, palm, and back of the hand, respectively.

17. The method of claim 10, wherein the tactile feedback module operates at least one vibration motor located at a point of collision with the virtual object, among the multiple vibration motors.

18. The method of claim 10, further comprising:
receiving, by the apparatus for providing haptic feedback, data in response to collision with the virtual object via a communication module.
